(19) United States
(12) Patent Application Publication
(10) Pub. No.: US 2023/0211295 A1
(43) Pub. Date: Jul. 6, 2023

(54) Device for Producing Energy by Salinity Gradient Through a Membrane Based on Crosslinked Cellulose Fibres

(71) Applicant: Sweetch Energy, Rennes (FR)

(72) Inventors: Bruno Mottet, Guidel (FR); Benoit Laborie, Rennes (FR); Mohammed Kechadi, Rennes (FR)

(21) Appl. No.: 17/998,991

(22) PCT Filed: May 19, 2021
(86) PCT No.: PCT/FR2021/050894

§ 371 Date: Nov. 16, 2022

(30) Foreign Application Priority Data
May 20, 2020 (FR) 2005211

(51) Int. Cl. B01D 69/12; H01M 8/22; B01D 71/10; H01M 8/0239

(52) U.S. Cl. CPC B01D 69/1214; H01M 8/227; B01D 71/10; H01M 8/0239

(57) ABSTRACT

The present invention concerns a device for producing electrical energy, comprising: a) a first reservoir A for receiving an electrolyte solution having a concentration CA of a solute and comprising an electrode (30A) in contact with the electrolyte solution having concentration CA; b) a second reservoir B for receiving an electrolyte solution having a concentration CB of one and the same solute, CB being lower than CA, and comprising an electrode in contact with the electrolyte solution having concentration CB; c) a membrane separating the two reservoirs, said membrane comprising pores allowing the electrolytes to diffuse from reservoir A to reservoir B through said pore or pores; and d) a device capable of supplying the electrical energy generated by the potential difference existing between the two electrodes, characterized in that the membrane comprises at least one layer formed of a cellulosic material comprising a network of crosslinked cellulose nanofibres and/or microfibres.

### RELATED APPLICATIONS

This application is a National Stage Application under 35 U.S.C. 371 of co-pending PCT application PCT/FR2021/050894 designating the United States and filed May 19, 2021; which claims the benefit of FR application number 2005211 and filed May 20, 2020, each of which are hereby incorporated by reference in their entireties.

### STATE OF THE ART

The production of energy by salinity gradient is one of the renewable energy sources with the greatest potential on a planetary scale.

Among the various technologies currently being considered, the reverse electrodialysis (RED) method is based on the use of membranes whose basic property is the selective transport of ions according to the sign of their charge. A RED device typically consists of alternating ion exchange membranes between which salt water and fresh water are circulated alternately. The circulation of alternating salt water and fresh water between these ion exchange membranes (IEMs) allows to establish an ion flux at each of the IEMs of the device. At the ends of this stack of membranes, electrodes collect the electric current generated by the overall ion flux.

One of the problems encountered by devices for producing electricity from a salinity gradient, such as the current RED devices, is that these devices have a very low electricity production capacity, due to the fact that current membranes develop electrical powers per unit area of membrane (that is to say membrane powers) of only a few W/m² of membrane.

In particular, IEMs weakly conduct ionic currents and constitute an important ohmic contribution to reverse electrodialysis systems. Furthermore, the preparation of these membranes is very expensive, which is why the major part of the maintenance investments of membrane methods is devoted to the replacement of these membranes.

An approach to this problem is set out in the international application published on Apr. 24, 2014 under number WO 2014/060690. In this approach, nanoporous membranes have been proposed the inner surface of the pores of which is covered with boron nitride or more generally with mixtures of the elements boron, carbon and nitrogen. These nanoporous membranes exploit diffusion-osmosis phenomena within the pores and develop membrane powers of the order of kW/m². More recently, provision has also been made, in the international application published on Mar. 9, 2017 under the number WO 2017/037213, of nanoporous membranes the inner surface of the pores of which is covered with titanium oxide, allowing to reach membrane powers of the order 5 kW/m². However, this approach involves the use of membranes based on boron nitride or titanium oxide, the preparation of which on a scale larger than that of the laboratory is complex and extremely expensive given the materials required. Moreover, the materials used in these membranes are potentially harmful, and have a risk if they are released into the environment.

There is therefore, in the light of the foregoing, a need for a device allowing the production of non-polluting, economical electrical energy and which allows to obtain an energy production per square meter of membrane which is of the order of kW/m².

### DISCLOSURE OF THE INVENTION

The inventors have discovered that a device for producing electrical energy from a salinity gradient including a membrane comprising a layer formed of a network of cellulose nanofibers and/or microfibers allows to obtain a production of energy per square meter of membrane which is of the order of kW/m².

The use of such membranes also allows to facilitate the development on a larger scale of a device for the production of energy by salinity gradient and to reduce its cost.

Thus, an object of the invention is to provide a device for producing energy by salinity gradient capable of developing a high membrane power, and using membranes that are economical and easy to prepare, which moreover has a limited risk for the environment.

Device

The first object of the invention is a device for producing electrical energy comprising:
a first reservoir A (20A) intended to receive an electrolytic solution (22A) having a concentration C_{A} of a solute and comprising an electrode (30A) in contact with the electrolytic solution having a concentration C_{A};
a second reservoir B (20B) intended to receive an electrolytic solution (22B) having a concentration C_{B} of the same solute, C_{B} being lower than C_{A}, and comprising an electrode (30B) in contact with the electrolytic solution having a concentration C_{B};
a membrane (10) separating the two reservoirs, said membrane comprising pores allowing the electrolytes to diffuse from reservoir A to reservoir B through said pore or pores; and
a device (32) allowing to supply the electrical energy generated by the potential differential existing between the two electrodes,

characterized in that the membrane comprises at least one layer formed of a cellulosic material comprising a network of crosslinked cellulose nanofibers and/or microfibers.

The electrical energy production device according to the present invention comprises two reservoirs, respectively reservoir A (20A) and a reservoir B (20B), separated by a membrane 10. Each of the two reservoirs A and B are intended to receive electrolytic solutions (22A, 22B) of respective concentrations C_{A} and C_{B} of the same solute, in which an electrode 30A and 30B is soaked. The two electrodes (30A, 30B) are connected to a device allowing to capture and then supply the electrical energy generated.

In order to generate an ion flux through the membrane, the concentrations C_{A} and C_{B} of the same solute of the electrolyte solutions (22A, 22B) are necessarily different.

In the context of the present invention, it will be arbitrarily considered that C_{B} is lower than C_{A}, which leads to a circulation of solute ions from reservoir A to reservoir B.

The membrane (10), separating the two reservoirs A and B, comprises pores allowing the electrolytes to diffuse from reservoir A to reservoir B through said pore or pores; The diffusion will take place from reservoir A to reservoir B. The pores have an average cross-section allowing both water molecules and solute ions to circulate.

The thickness of the membrane is advantageously of between 2 μm and 100 μm, preferably between 2 μm and 75 μm.

The membrane advantageously comprises from 10 to 20 g of cellulosic material per m² of membrane, preferably 15 to 20 g of cellulosic material per m² of membrane.

The electrodes (30A, 30B) can be partially or entirely immersed in the electrolyte solutions (22A, 22B). It is also possible to provide that the electrodes are in the form of at least part of a wall of the reservoirs.

The device (32) allows to capture then supply the electrical energy spontaneously generated by the potential differential existing between the two electrodes (30A) and (30B). It can consist of simple cables connecting a battery, a bulb or any other form of electrical consumer.

In the device according to the invention, the electrical energy is generated thanks to the difference in the concentrations C_{A} and C_{B} of the same solute of the electrolytic solutions which causes the mobility of the electrolytes, more particularly of the ions resulting from said electrolytes, from the most concentrated solution towards the less concentrated solution, through the porosity of the material(s) of the membrane and under the influence of their surface properties, in particular their surface charge.

The inventors have discovered that, completely unexpectedly, a membrane based on nanofibers and/or cellulose develops a very high membrane power, of the order of several hundred W/m² of membrane, under the effect of a salinity gradient.

Without wanting to be bound by a particular theory, the inventors believe that this unexpected membrane power is determined by the surface charge of the nanofibers and/or cellulose, as well as by the geometry of the network that they form, which allow very good selective ion conduction through the membrane.

In particular, still according to the inventors, the porosity and the charge of the charge surface within the network of cellulose nanofibers and/or microfibers unexpectedly influence the selective passage of ions through the membrane, thus allowing the membrane to develop unexpected membrane power.

The surface charge density of the internal wall of the pores of the membrane is advantageously between 0.001 and 3 C/m², preferably is between 0.1 and 1 C/m².

The surface charge density of the membrane can be measured by dosimetry.

Cellulose Nanofibers and/or Microfibers

According to the invention, the term “crosslinked”, relating to cellulose nanofibers and/or microfibers, means that said fibers are connected to each other by covalent chemical bonds (sometimes called “bridges”) so as to form a three-dimensional network under cellulosic matrix form. In other words, they are not simply agglomerated by or self-assembled through weak bonds.

The covalent chemical bonds involved in the crosslinking of cellulose nanofibers and/or microfibers can also carry charged groups and/or groups which become charged in the presence of water, as is for example the case when the crosslinking agent used is citrate. In this case, the crosslinking chemical bonds play both a role in the structure and in the electrical surface charge of the outer layers (101,103).

The network of cellulose nanofibers and/or microfibers advantageously has pores with a diameter of between 10 and 1000 nm.

According to the invention, the expression cellulose “nanofiber” designates a 3-dimensional object and based on cellulose in which 2 of the 3 external dimensions are at the nanometric scale (that is to say 2 of the 3 dimensions range from 1 to 100 nm), the 3^{rd} external dimension being significantly larger than that of the other two dimensions, and not necessarily being at the nanometric scale.

The cellulose nanofibers advantageously have a diameter ranging from 1 to 100 nm, preferably ranging from 1 to 70 nm, and more preferably ranging from 4 to 30 nm, in particular from 4 to 20 nm. Furthermore, their length is advantageously between 0.5 and 100 μm, in particular between 0.5 and 50 μm, for example between 0.5 and 10 μm, for example still between 0.5 and 2 μm.

According to the invention, the expression cellulose “microfiber” designates a 3-dimensional object in which 2 of the 3 external dimensions are on the micrometric scale (that is to say 2 of the 3 dimensions range from 0.1 to 1 μm), the 3^{rd} external dimension being significantly greater than that of the other two dimensions.

The cellulose microfibers advantageously have a diameter ranging from 100 to 1000 nm, preferably ranging from 100 to 700 nm, and more preferably ranging from 100 to 200 nm. Furthermore, their length is advantageously between 0.5 and 100 μm, in particular between 1 and 50 μm, for example between 1 and 10 μm, for example still between 1 and 5 μm.

The cellulose nanofibers and/or microfibers advantageously have a form factor advantageously greater than 30, preferably greater than 100.

Advantageously, the cellulosic material comprises at least 90% by mass of cellulose nanofibers and/or microfibers, at least 95% by mass of cellulose nanofibers and/or microfibers, more preferably still at least 99% of cellulose nanofibers and/or microfibers, relative to the mass of cellulosic material.

Cellulose nanofibers and/or microfibers can be obtained by techniques known to the person skilled in the art, in particular by mechanical, enzymatic or chemical treatment of a lignocellulosic material of natural origin such as wood.

In the case of wood, these treatments have the particular effect of separating the cellulose from the other constituents of the wood such as lignin and hemicellulose. For this purpose, the natural cellulose fibers are pre- or post-treated chemically, in particular with enzymes, and/or mechanically to initiate the destructuring before mechanical treatment in a homogenizer. It is known that the size and in particular the diameter of the cellulose fibers of said material can be modulated depending on the treatment to which the source of natural cellulose is subjected.

Thus, cellulose nanofibers and/or microfibers can be obtained by mechanical treatment of wood fibers, the mechanical treatment being carried out so as to provide sufficient mechanical energy to burst the fibers of the natural cellulose by destroying at least in part hydrogen bonds that hold the microfibrils together. Mechanical treatment is often preceded by a chemical or enzymatic treatment step. For example, this treatment step can be an oxidation treatment, in particular using an oxidant such as TEMPO (2,2,6,6-tetramethylpiperidin-1-yl)oxy). The product thus obtained is often referred to as “nanofibrillated Cellulose” (abbreviated “NFC”), “cellulose nanofibers” (abbreviated “CNF”) or “microfibrillated Cellulose” (abbreviated “MFC”) in the literature.

In general, MFC materials are prepared from a less extensive mechanical and/or chemical treatment than that used to obtain NFCs, and generally have fibers with diameters greater than those observed in NFCs. However, there is no unambiguous definition of MFC and NFC/CNF, so that these terms are often used interchangeably in the literature.

The cellulose nanofibers and/or microfibers are preferably nanocellulose nanofibers and/or microfibers.

The cellulosic material may in particular comprise at most 5% by mass of hemicellulose, more preferably at most 3% by mass of hemicellulose, or else at most 1% by mass of hemicellulose.

The cellulosic material may in particular comprise at most 5% by mass of lignin, more preferably at most 3% by mass of lignin, or else at most 1% by mass of lignin.

The cellulose nanofibers and/or microfibers of the invention intrinsically carry a negative surface charge due to the fact that the cellulose monomers naturally carry alcohol groups at their C2, C3 or C6 carbon atoms.

In one embodiment, the intrinsic negative surface charge of the cellulose nanofibers and/or microfibers of the invention can be increased by functionalizing them with negatively charged groups and/or groups which become negatively charged in the presence of water. This embodiment is particularly advantageous when the charged groups and/or groups which become charged in the presence of water of the functionalized nanoparticles of the inner layer (102) have a negative sign. Indeed, this has the advantage of increasing the surface charge of the entire composite membrane of the invention.

The charged groups and/or groups which become charged in the presence of water carried by the microfibers and/or the nanofibers are advantageously bonded chemically in a covalent manner to the surface of said cellulose microfibers and/or nanofibers.

Any charged group and/or group which becomes charged in the presence of water in the latter known to the person skilled in the art and allowing to increase the charge density of the microfibers and/or of the cellulose nanofibers of the invention can be used in the scope of the present invention.

Advantageously, the charged groups and/or groups which become charged in the presence of negatively charged water carried by the cellulose nanofibers and/or microfibers are selected from the sulfonate group —SO₃⁻, the carboxylate group —CO₂, the carboxyalkyl group R—CO₂⁻ with R a C1-C4 and preferably C1 alkyl, the aminodiacetate group —N(CH₂CO₂⁻)₂, the phosphonate group PO₃²⁻; the amidoxine group —C(═NH₂)(NOH), the aminophosphonate group —CH₂—NH—CH₂—PO₃²⁻, the thiol group —SH, and mixtures thereof.

The carboxylate group —CO₂⁻ and the carboxyalkyl group R—CO₂⁻ with R a C1-C4 and preferably C1 alkyl are preferred.

Thus, cellulose nanofibers and/or microfibers carrying —CO₂⁻ carboxylate groups (that is to say oxidized cellulose nanofibers and/or microfibers) can for example be obtained by oxidation, for example by TEMPO oxidation, of nanofibers and/or microfibers of cellulose. The oxidation occurs preferentially on the primary alcohol group carried by the C6 carbon atom of the monomers of the cellulose nanofibers and/or microfibers.

Cellulose nanofibers and/or microfibers carrying carboxyalkyl groups R—CO₂⁻ (that is to say carboxylalkylated cellulose nanofibers and/or microfibers) can for example be obtained by etherification of cellulose nanofibers and/microfibers. Etherification occurs preferentially on the alcohol groups carried by the C2, C3 or C6 carbon atoms of monomers of the cellulose nanofibers and/or microfibers.

In another embodiment, the intrinsic negative surface charge of the cellulose nanofibers and/or microfibers of the invention can be reversed by functionalizing them with charged groups and/or groups which become charged in the presence of water having a positive electrical charge.

This embodiment is preferred when the charged groups and/or groups which become charged in the presence of water of the functionalized nanoparticles of the inner layer (102) have a positive sign.

Any charged group and/or group which becomes charged in the presence of water known to the person skilled in the art and allowing to confer a positive surface charge on cellulose nanofibers and/or microfibers can be used in the context of the present invention.

Advantageously, the positively charged groups and/or groups which become positively charged in the presence of water are selected from the quaternary ammonium group —N(R)₃⁺ with R a C1-C4 alkyl, the tertiary ammonium group —N(H)R)₂⁺ with R a C1-C4 alkyl, preferably a C1 alkyl, the dimethylhydroxyethylammonium group —N(C₂H₄OH)CH₃)₂⁺, and mixtures thereof.

Quaternary ammonium groups are preferred.

Monolayer Membrane

In a first embodiment, the invention relates to a device according to the invention whose membrane comprises a single layer (101) formed of a cellulosic material as defined above.

The inventors have shown that, surprisingly, a membrane comprising a single layer (101) formed of a network of crosslinked cellulose nanofibers and/or microfibers allows to develop surprisingly high membrane powers compared to the membranes of the prior art, and compatible with industrial exploitation.

The thickness of the membrane comprising a single layer (101) is advantageously between 2 μm and 50 μm, preferably between 5 μm and 20 μm, more preferably between 10 μm and 20 μm.

In the invention, the thickness of the membrane and of the different layers is measured by scanning electron microscopy of sections of dry membrane.

Method for Preparing a Monolayer Membrane

A membrane comprising a single layer can easily be prepared by a method comprising the steps of:

i) filtering a solution comprising cellulose nanofibers and/or microfibers on a filtration support so as to form a layer comprising nanofibers and/or microfibers;

ii) filtering a crosslinking solution capable of crosslinking the cellulose nanofibers and/or microfibers of the layer obtained in step i);

iii) drying the product of step ii), preferably in an oven;

iv) removing the filtration support, so as to obtain a membrane comprising a layer.

The method is simple, easy to implement, economical and allows the thickness of each layer of the composite membrane to be controlled.

The cellulose nanofibers and/or microfibers used in the method are as defined in the first object of the invention.

The filtration of steps i) and ii) is advantageously carried out with a vacuum pump, preferably under 1 bar of vacuum.

The solution of cellulose nanofibers and/or microfibers comprises from 0.1% to 1% by weight of cellulose nanofibers and/or microfibers, preferably from 0.3% to 0.6% by weight of cellulose nanofibers and/or microfibers.

The nanofibers and/or the microfibers of the solution of step i) can be functionalized, as detailed in the first object of the invention.

The crosslinking solution implemented in step ii) advantageously comprises from 0.005 M to 0.02 M of one or more crosslinking agents, preferably from 0.008 M to 0.012 M of one or more crosslinking agents.

As detailed above, the crosslinking agent preferentially carries charged groups and/or groups which become charged in the presence of water.

Any other technique known to the person skilled in the art can be considered, whether discontinuously (that is to say by batch), or continuously, for example by the technique called “roll-to-roll processing” technique in which the membrane is produced continuously and then stored in the form of a roll.

Composite Membrane

In a second embodiment, the device includes a composite membrane comprising two outer layers (101, 103) each formed of a cellulosic material as defined above, between which is disposed an inner layer (102) formed of a second material comprising nanoparticles functionalized by charged groups and/or groups which become charged in the presence of water.

The second material advantageously has pores with a diameter of between 10 and 100 nm.

The inventors have discovered that, unexpectedly, such a composite membrane develops a membrane power that is significantly even higher than that of a membrane comprising a single layer (101) as defined above.

Without wanting to be bound by a particular theory, the inventors believe that this improvement in membrane power is due to a synergistic effect between, on the one hand, the properties of the network of cellulose nanofibers and/or microfibers, and on the other hand those of the layer of nanoparticles functionalized by charged groups. The thickness of the composite membrane is advantageously preferably between 4 μm and 100 μm, more preferably between 4 μm and 75 μm.

The thickness of each of the outer layers (101,103) is advantageously between 2 μm and 45 μm, preferably between 2 μm and 30 μm. Said outer layers advantageously have the same thickness. The thickness of the inner layer (102) is in turn advantageously between 10 nm and 2 μm, 10 nm and 1 μm, 10 nm and 800 nm, preferably between 10 nm and 400 nm, preferably between 200 nm and 500 nm.

Preferably, the thickness of each of the outer layers (101, 103) is advantageously between 2 μm and 25 μm, and the thickness of the inner layer (102) is between 10 nm and 2 μm.

According to the inventors, the very small thickness of the inner layer (102) allows to obtain excellent permeability while increasing the selective conduction of ions significantly.

Preferably, the membrane comprises less than 10% by weight of second material relative to the weight of cellulosic material, preferably between 2% and 8% by weight of second material relative to the weight of cellulosic material, more preferably between 3% and 5% by weight of second material relative to the weight of first material.

In this embodiment, the cellulosic material of the outer layers (101, 103) ensures the integrity of the inner layer (102), in particular during its use, the latter is subjected to a stress such as a pressure gradient on either side of the membrane.

Preferably, the nanofibers and/or the microfibers of the outer layers (101, 103) carry charged groups or groups which become charged in the presence of water, said groups advantageously having a charge of the same sign as that of the charged groups or groups which become charged in presence of water of the functionalized nanoparticles of the inner layer (102).

This has the advantage of increasing the surface charge of the entire membrane.

According to the inventors, the presence of these charged groups or groups which become charged in the presence of water of the same sign within the inner layer (102) and the outer layers (101,103) of the membrane allow to obtain a synergistic effect, namely an unexpected improvement in the selective conduction of ions through the membrane.

In this embodiment, the cellulosic material therefore plays a role in the structure of the membrane and in its ability to ensure selective conduction of ions.

Moreover, the covalent chemical bonds involved in the crosslinking of nanofibers and/or microfibers can also carry charged groups and/or groups which become charged in the presence of water, as is for example the case when the crosslinking agent used is citrate. In this case, the crosslinking chemical bonds play both a role in the structure and in the electrical surface charge of the outer layers (101,103).

Functionalized Nanoparticles

According to the invention, the term “nanoparticle” designates a 3-dimensional object, in which at least one external dimension is located on the nanometric scale (that is to say at least one dimension is in a range between 1 and 100 nm).

The second material advantageously comprises the nanoparticles in the form of individual nanoparticles, that is to say nanoparticles which are not aggregated or in other words covalently bound to each other.

The second material advantageously comprises at least 50% by mass of nanoparticles, at least 95% by mass of nanoparticles, more preferably at least 99% of nanoparticles, relative to the mass of second material.

Advantageously, the nanoparticles are not in the form of nanotubes.

The nanoparticles are preferably lamellar nanoparticles.

According to the invention, the term “lamellar nanoparticle” designates a nanoparticle comprising atoms in the form of monolayers of atoms bound together by covalent bonds. Lamellar nanoparticles can consist of a single monolayer of atoms (2D materials) or a stack of 2 to 5 monolayers of atoms bound together by weak bonds, such as Van der Waals forces.

In other words, a lamellar nanoparticle is a 3-dimensional object in which a first external dimension is at the nanometric scale and the two other dimensions are significantly greater than the first dimension, and vary in particular between the nanometric and the micrometric scale.

The lamellar nanoparticles preferably have a median size (also designated by the acronym “D50”) comprised between 5 μm and 50 μm, preferably comprised between 10 μm and 20 μm, more preferably 15 μm.

According to the invention, the terms “monolayer”, “bilayer”, “few-layers”, relating to lamellar nanoparticles, denote a lamellar nanoparticle respectively consisting of a monolayer of atoms, two monolayers of atoms, and of 3 to 5 monolayers of atoms. Bilayer and few-layer lamellar nanoparticles are typically stabilized by weak interactions between atomic monolayers, such as Van der Waals interactions.

The lamellar nanoparticles are preferably lamellar nanoparticles of a metal oxide, in particular of SnO₂ or of TiO₂, lamellar nanoparticles of a dichalcogenide of a transition metal such as molybdenum disulfide MoS₂, lamellar nanoparticles of carbon, or a mixture thereof.

The lamellar carbon nanoparticles are advantageously lamellar nanoparticles of monolayer graphene, of bilayer graphene, of few-layer graphene or a mixture thereof.

Monolayer graphene nanoparticles are preferred.

According to the invention, monolayer graphene is to a two-dimensional crystalline material consisting of carbon in a particular allotropic form, which can be represented as a planar honeycomb. More specifically, monolayer graphene is a sheet consisting of a single sp² hybridized carbon atomic plane. It can therefore be described as monolayer.

According to the invention, bilayer graphene (or BLG) is a material consisting of a stack of 2 monolayers of graphene stabilized by van der Waals type interactions between the 2 monolayers of graphene. BLG can be obtained by exfoliation of graphite or by chemical vapor deposition (CVD).

According to the invention, few-layer graphene (or FLG) is a material consisting of a stack of 3 to 5 sheets of graphene, stabilized by van der Waals type interactions between the different graphene planes.

The lamellar carbon nanoparticles are advantageously lamellar nanoparticles of monolayer molybdenum disulfide, bilayer molybdenum disulfide, few-layer molybdenum disulfide or a mixture thereof.

Depending on the sign of their charge, the charged groups or groups which become charged in the presence of water confer a negative or positive surface charge on the inner layer (102) of the composite membrane when placed in the presence of water.

Any charged group or group which becomes charged in the presence of water known to the person skilled in the art and allowing to increase the surface charge of graphene particles can be used in the context of the present invention.

In one embodiment, the nanoparticles are functionalized at the surface by negatively charged groups and/or which groups become negatively charged in the presence of water.

The negatively charged groups and/or groups which become negatively charged in the presence of water are advantageously selected from the epoxide group, the hydroxyl group, the carbonyl group, the carboxyl group, the sulfonate group —SO₃⁻, the carboxyalkyl group R—CO₂⁻ with R a C1-C4 and preferably C1 alkyl, the aminodiacetate group —N(CH₂CO₂⁻)₂, the phosphonate group PO₃²⁻; the amidoxine group —C(═NH₂)(NOH), the aminophosphonate group —CH₂—NH—CH₂—PO₃²⁻, the thiol group —SH, and mixtures thereof.

Preferably, the nanoparticles functionalized at the surface by negatively charged groups or groups which become negatively charged in the presence of water are lamellar nanoparticles of graphene oxide (or GO).

The lamellar graphene oxide nanoparticles bear negatively charged groups or groups that become negatively charged in the presence of water, advantageously selected from the epoxide group, the hydroxyl group, the carbonyl group, the carboxyl group, and mixtures thereof.

In one embodiment, the nanoparticles are functionalized at the surface by positively charged groups and/or groups which become positively charged in the presence of water.

Advantageously, the positively charged groups and/or groups which become positively charged in the presence of water are selected from the quaternary ammonium group —N(R)₃⁺ with R a C1-C4 alkyl, the tertiary ammonium group —N(H)R)₂⁺ with R a C1-C4 alkyl, preferably a C1 alkyl, the dimethylhydroxyethylammonium group —N(C₂H₄OH)CH₃)₂⁺, and mixtures thereof.

Method for Preparing a Composite Membrane

The composite membrane according to the second embodiment can be prepared by a method comprising the steps consisting in:

i) filtering a solution comprising cellulose nanofibers and/or microfibers on a filtration medium so as to form a first outer layer (101) comprising cellulose nanofibers and/or microfibers;

ii) filtering a solution of particles of functionalized nanoparticles on the outer layer (101) obtained at the end of step i) so as to form an inner layer (102) on said first outer layer (101);

iii) filtering a solution of cellulose nanofibers and/or microfibers so as to form a second outer layer (103) comprising nanofibers and/or microfibers on the inner layer (102) obtained at the end of step ii);

iv) filtering a crosslinking solution capable of crosslinking the cellulose nanofibers and/or the microfibers of the outer layers (101,103);

v) drying the product of step iv), in the oven;

vi) removing the filtration support, so as to obtain a composite membrane.

The cellulose nanofibers and/or microfibers and the nanoparticles functionalized at the surface by charged groups and/or groups which become charged in the presence of water are as defined in the first object of the invention.

The method is simple, easy to implement, economical and allows the thickness of each layer of the composite membrane to be controlled.

The filtration of steps i), ii), iii) and iv) is advantageously carried out with a vacuum pump, preferably under 1 bar of vacuum.

The filtration of step i) can optionally be followed by a step i₁) consisting in filtering a crosslinking solution on the outer layer obtained at the end of step i).

The filtration of step ii) can optionally be followed by a step ii₁) consisting in filtering a crosslinking solution on the inner layer (102) obtained at the end of step ii).

The solution of nanofibers and/or microfibers implemented in steps i) and iii) comprises from 0.1% to 1% by weight of cellulose nanofibers and/or microfibers, preferably from 0.3% to 0.6% by weight of cellulose nanofibers and/or microfibers.

The nanofibers and/or the microfibers of the solution of steps i) and iii) can be functionalized, as detailed in the first object of the invention.

The solution of functionalized nanoparticles implemented in step ii) comprises from 0.001% to 0.01% by weight of nanoparticles, preferably from 0.003% to 0.006% by weight of functionalized nanoparticles.

The crosslinking solution implemented in step iv) advantageously comprises from 0.005 M to 0.02 M of one or more crosslinking agents, preferably from 0.008 M to 0.012 M of one or more crosslinking agents.

The drying of step v) is advantageously carried out at a temperature allowing the crosslinking reaction to occur and below a temperature damaging the fibers and/or the nanofibers. Preferably, the drying is carried out at a temperature comprised between 80° C. and 150° C., in particular between 80° C. and 120° C., more preferably still comprised between 80° C. and

As detailed above, the crosslinking agent preferentially carries charged groups and/or groups which become charged in the presence of water.

Any other technique known to the person skilled in the art can be considered, whether discontinuously (that is to say by batch), or continuously, for example by the technique called “roll-to-roll processing” technique) in which the membrane is produced continuously and then stored in the form of a roll.

Other Components of the Device

Reservoirs A and B of the device according to the invention each contain an electrolytic solution (22A, 22B) having a respective concentration C_{A} and C_{B} of the same solute, C_{B} being lower than C_{A}.

Each reservoir A and B can be any device or natural environment, open or closed, capable of containing a liquid.

By placing electrolyte solutions of different concentrations in the two reservoirs A and B, an osmotic flow is generated between the two reservoirs, preferably by diffusio-osmosis, that is to say without any osmotic pressure appearing. In another embodiment, the concentration gradient could also be obtained by temperature gradient between the two reservoirs by acting on the solubility of the salt as a function of the temperature.

In the context of the present invention, the concentration ratio Rc (Rc being equal to the ratio of the concentration of the most concentrated solution/the concentration of the least concentrated solution) may be between 1 and 10⁹. Preferably, the concentration ratio C_{A}/C_{B} is greater than 1 and less than or equal to 10⁹, advantageously greater than 10 and less than or equal to 10⁵.

Electrolyte solutions are aqueous solutions comprising electrolytes. The electrolytes may be of any chemical nature insofar as they dissolve in the solution in the form of charged ions. Preferably, these ions will come from dissolved salts such as NaCl, KCl, CaCl₂ and MgCl₂. Electrolyte solutions can be:
synthetic solutions;
natural solutions, such as fresh water from lakes or rivers, underground water, brackish water, sea water;
industrial production water, oil production water or biological solutions.

Preferably, said electrolyte solutions are aqueous solutions comprising a solute selected from alkali halides or alkaline earth halides, preferably selected from NaCl, KCl, CaCl₂ and MgCl₂, more preferably the solute is NaCl.

To improve the osmotic flow generated on either side of the membrane according to the invention, the pH of the solutions can be adjusted according to the isoelectric point of the material(s) constituting the membrane.

In the context of the present invention, pHᵢₛₒ means the pH of the isoelectric point of the material or materials constituting the membrane. The pHᵢₛₒ is measured by methods known to the person skilled in the art, in particular by the acid/base potentiometric titration method.

Even more favorably, to increase the asymmetry of the device and amplify the amount of electrical energy produced by the device, a pH gradient may also be established between the two reservoirs, the difference in pH between the two solutions will be greater than 1, preferably greater than 2.

Each of the reservoirs A and B of the device according to the invention also comprises an electrode (30A, 30B) disposed so as to contact the electrolytic solution (22A, 22B).

Different types of electrodes can be used to recover the potential or electric current developed between the two reservoirs.

All types of electrodes capable of collecting the flux of Na⁺ or Cl⁻ ions can be used, and preferably electrodes composed of Silver and Silver Chloride (Ag/AgCl), Carbon and Platinum (C/Pt—), Carbon (C—), Graphite or iron complexes of the [Fe(CN)6]⁴⁻/[Fe(CN)6]³⁻ type.

The electrodes can be partially or completely immersed in the electrolyte solutions. Provision could also be made for the electrodes to take the form of at least part of a wall of the reservoirs.

The electrodes can in particular be circulation electrodes (“redox-flow”). The principle of these electrodes is based on an oxidation reaction and a reduction reaction at each of the electrodes.

The electrodes are preferably capacitive or supercapacitive electrodes. The principle of these electrodes is based on an interaction of the electrodes and the electrolyte which leads to the spontaneous appearance of an accumulation of charges at the interfaces.

These electrodes are connected together to a device (32) allowing to capture then supply the electrical energy spontaneously generated by the potential differential existing between them. These electrodes can in particular be connected by simple cables connecting a battery, a bulb or any other form of electrical consumer.

The device thus described allows to collect the electrical energy resulting from the charged ion flux traversing the nano-fluidic membrane.

In a particular embodiment of the invention, the device can comprise N reservoirs (20) and N−1 membranes (10), N being an integer, in particular between 3 and 100, in particular between 3 and 50.

In this device, the reservoirs and the membranes are as defined above. The assembly will therefore consist of alternating reservoirs containing alternately a concentrated electrolytic solution and a less concentrated electrolytic solution, separated from each other by membranes.

Electrical Energy Production Method

The second object of the invention is a method for producing electrical energy using a device as described in the first object of the invention comprising the following steps:

i) supplying an electrolytic solution (22A) having a solute concentration C_{A} in reservoir A (20A), so that the electrode (30A) with which it is equipped is in contact with said solution (22A),

ii) supplying an electrolytic solution (22B) having a concentration C_{B} of the same solute, C_{B} being lower than C_{A}, in the reservoir B (20B), so that the electrode (30B) with which it is equipped is in contact with said solution (22B),

iii) allowing the electrolytes to diffuse from reservoir A to reservoir B through the membrane (10),

iv) capturing the electrical energy generated by the potential differential existing between the two electrodes, using the device (32).

Steps i) and ii) are preferably implemented by supplying the electrolytic solution having a concentration C_{A} and the electrolytic solution having a concentration C_{B} in the form of a continuous flow.

More generally, these different steps will be easily carried out by the person skilled in the art, using their general knowledge.

### DESCRIPTION OF THE FIGURES

FIG. 1 schematically shows an example of an electrical energy production device according to the present invention, comprising two reservoirs 20A and 20B, respectively reservoir A and reservoir B, separated by a membrane 10. Each of the two reservoirs contains an electrolytic solution 22A and 22B having a respective concentration C_{A} and C_{B} of the same solute, in which an electrode 30A and 30B is soaked. The two electrodes 30A and 30B are connected to a device allowing to capture and then supply the electrical energy generated. Each reservoir A and B can be any device or natural environment, open or closed, capable of containing a liquid. In order to generate an ion flux through the membrane, the concentrations C_{A} and C_{B} of the same solute of the electrolyte solutions 22A and 22B are necessarily different. In the context of the present invention, it is arbitrarily considered that C_{B} is lower than C_{A}, which causes circulation of the ions of the solute from reservoir A to reservoir B. The membrane 10, separating the two reservoirs A and B comprises pores allowing the electrolytes to diffuse from reservoir A to reservoir B through the pores. The diffusion will take place from reservoir A to reservoir B. The pores have an average cross-section allowing both water molecules and solute ions to circulate. The electrodes 30A and 30B can be partially or entirely immersed in the solutions 22A and 22B. It is also possible to provide that the electrodes are in the form of at least part of a wall of the reservoirs. The device (32) allows to capture then supply the electrical energy spontaneously generated by the potential differential existing between the two electrodes 30A and 30B. It can consist of simple cables connecting a battery, a bulb or any other form of electrical consumer.

FIG. 2 schematically shows in section an example of membrane (10) according to the invention including a single layer (101) formed of a cellulosic material comprising nanofibers and/or crosslinked cellulose microfibers.

FIG. 3 schematically shows in section an example of membrane (10) according to the invention, in which the membrane is a composite membrane comprising two outer layers (101,103) each formed of a cellulosic material comprising crosslinked cellulose nanofibers and/or microfibers, between which is disposed an inner layer (102) formed of a material comprising nanoparticles functionalized at the surface by charged groups and/or groups which become charged in the presence of water.

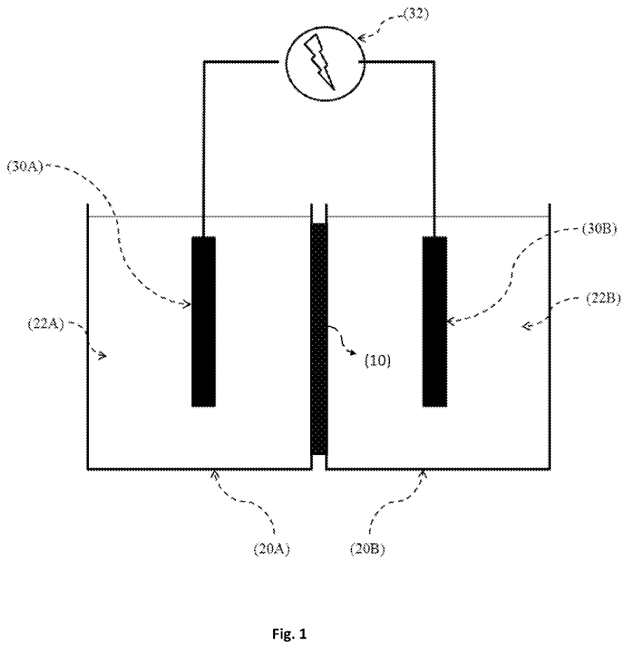

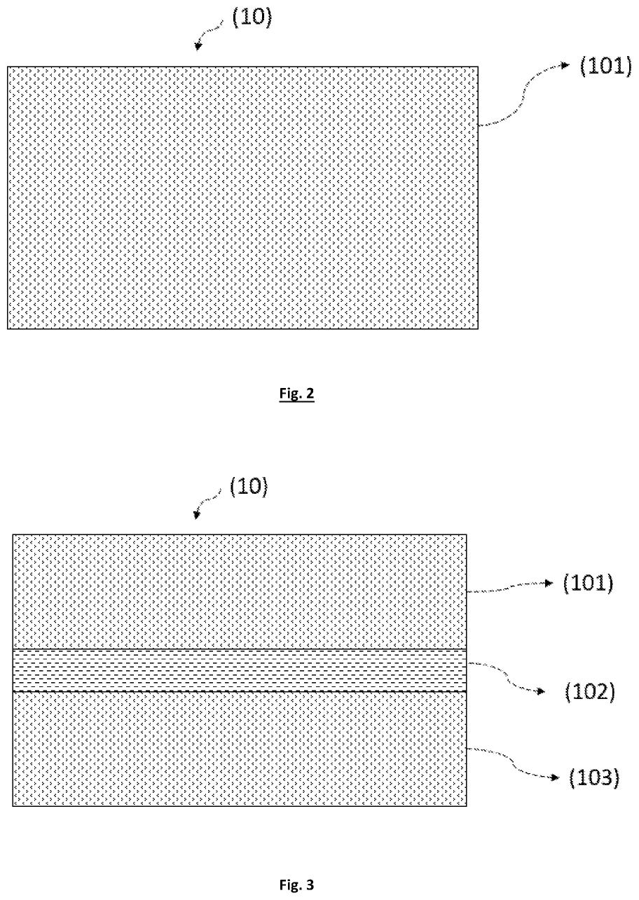

### EXAMPLES

The present invention will be better understood upon reading the following examples which illustrate the invention without limitation.

### Example 1: Preparation and Measurement of the Membrane Power of a Monolayer Membrane

### Equipment and Raw Materials

The material used is listed below:

A Buchner filter

A 1 bar vacuum pump

0.1 μm PVDF filter paper

A proofing oven

The raw materials used in this example are listed below:

Cellulose nanofibers negatively charged by carboxymethylation or TEMPO oxidation;

Citric acid, 99% by volume.

### Preparation of Monolayer Membranes

The preparation method used is as follows:
3.5 ml of nanocellulose solution are filtered on the buchner filter with a PVDF filter. The vacuum pump is set to 1 bar vacuum;
Once all the solution has been filtered, 10 ml of citric acid solution is filtered thereon (which acts as a crosslinking agent between the nanofibers);
Once all the filtered citric acid solution stops the pump, the Buchner device is opened and the filter paper with its filtrate is removed.
   The filtrate filter paper assembly is then placed in a study oven at 85° C. for 15 minutes (drying and crosslinking reaction).
   Finally, the membrane is detached from its filtration medium, to make things easier, it may possibly be soaked beforehand in an isopropanol solution.
   The membranes thus obtained are composed of 17.5 g/m² of nanocellulose.
   These membranes have an inner layer of graphene oxide having a thickness of about 100 nm, and outer layers of cellulose each having a thickness of about 10 μm.

### Membrane Power of the Monolayer Membrane

The tests were carried out with a device made up of two independent reservoirs each containing a solution of sodium chloride (NaCl) dissolved at 1M for the concentrated solution, then 0.1 M, 0.01 M and 0.001 M in dilute solution allowing to set the Rc gradient of 10, 100 and 1000 between the two reservoirs.
The two reservoirs are separated by a composite membrane in accordance with the invention obtained as detailed in Example 1.
Silver grid Ag/AgCl electrodes are immersed in each of the reservoirs on either side of the membrane to measure the electric current produced through the membranes.
The results are presented in Table 1.

TABLE 1
Cellulose NFC membrane

| Concentration gradient | 1 000 | 100 | 10 |
|---|---|---|---|
| U (mV) | 220 | 150 | 95 |
| R (Ohm · cm²) | 0.08 | 0.08 | 0.0725 |
| I (mA) | 2750 | 1 875 | 1 310 |
| Pmax W/m² | 1513 | 703 | 311 |
| U Nernst (mV) | 140 | 90 | 45 |
| U Osmo (mV) | 80 | 60 | 150 |
| I Nernst (mA) | 1 750 | 1 125 | 621 |
| I Osmo (mA) | 1 000 | 750 | 690 |
| P Osmo Max (W/m²) | 200 | 113 | 86 |

### With:

U Osmo the potential linked to the membrane from which the Nernst potential of the electrodes is deduced (U Nernst)

I Osmo the current linked to the membrane, calculated by measuring the electrical resistance of the membrane according to Ohm's law I=U/R

P Osmo Max is calculated by the formula Pmax=(U×I)/4

The membrane powers are expressed in W/m² by multiplying by 10 000 the values obtained on 1 cm² of membrane.

### Example 2: Preparation and Measurement of the Membrane Power of a Composite Membrane

### Equipment and Raw Materials

The material used is the same as that detailed in Example 1.
The raw materials used in this example are listed below:

Cellulose nanofibers negatively charged by carboxymethylation or TEMPO oxidation;

Citric acid, 99% by volume;

Graphene oxide marketed by the company Sigma Aldrich under the reference no 777676.

### Preparation of the Composite Membrane

The preparation method implemented in this example is detailed below:
1.75 ml of nanocellulose solution is filtered on the buchner filter with a PVD filter. The vacuum pump is set to 1 bar vacuum;
Once all the solution has been filtered, 5 ml of citric acid solution is refiltered thereon (which will act as a crosslinking agent between the nanofibers);
Once the citric acid has been filtered, 7 ml of graphene oxide solution is filtered
Once the graphene oxide solution has been filtered, 1.75 ml of nanocellulose solution is refiltered;
Once all the solution has been filtered, 5 ml of citric acid solution is refiltered thereon (which will act as a crosslinking agent between the nanofibers);
Once all the filtered citric acid solution stops the pump, the Buchner device is opened and the filter paper with its filtrate is removed.
   The filter paper/filtrate combination is then placed in a study oven at 85° C. for 15 minutes (drying and crosslinking reaction).
   Finally, the membrane is detached from its filtration medium, to make things easier, it may possibly be soaked beforehand in an isopropanol solution.
   The membranes thus obtained are composed of 17.5 g/m² of nanocellulose and 0.34 g/m² of graphene oxide (2% by mass).
   The nanocellulose contents and the mass contents of graphene oxide were varied. Nanocellulose contents below 10 mg/m² do not allow to obtain membranes with sufficient mechanical strength.
   For reasons of mechanical strength and ionic resistance, these values of 17 g/m² of cellulose and 4% by weight of graphene oxide seem optimal.

### Membrane Power of the Composite Membrane

The tests were carried out with a device made up of two independent reservoirs each containing a solution of sodium chloride (NaCl) dissolved at 1 M for the concentrated solution, then 0.1 M, 0.01 M and 0.001 M in dilute solution allowing to set the Rc gradient of 10, 100 and 1000 between the two reservoirs.
The two reservoirs are separated by a composite membrane in accordance with the invention obtained as detailed in Example 1.
Silver grid Ag/AgCl electrodes are immersed in each of the reservoirs on either side of the membrane to measure the electric current produced through the membranes.
The results of these measurements are shown in Table 2.

TABLE 2
Cellulose NFC membrane + 2% graphene oxide

| Concentration gradient | 1 000 | 100 | 10 |
|---|---|---|---|
| U (mV) | 330 | 250 | 151 |
| R (Ohm · cm²) | 0.16 | 0.16 | 0.145 |
| I (mA) | 2063 | 1 563 | 1 041 |
| Pmax W/m² | 1702 | 977 | 393 |
| U Nernst (mV) | 140 | 90 | 45 |
| U Osmo (mV) | 190 | 160 | 106 |
| I Nernst (mA) | 875 | 563 | 310 |
| I Osmo (mA) | 1 188 | 1 000 | 731 |
| P Osmo Max(W/m²) | 564 | 400 | 194 |

### With:

U Osmo the membrane potential from which the Nernst potential of the electrodes is deduced (U Nernst)

I Osmo the current linked to the membrane, calculated by measuring the electrical resistance of the membrane according to Ohm's law I=U/R

P Osmo Max is calculated by the formula Pmax=(U×I)/4

The membrane powers are expressed in W/m² by multiplying by 10 000 the values obtained on 1 cm² of membrane.
It has also been observed that by applying a pressure of 3 to 4 bars to the membrane between two metal plates during heating at 85° C., the mechanical stability of the membrane is improved by 10 to 20%.

1. A device for producing electrical energy comprising:
a) a first reservoir A intended to receive an electrolytic solution having a concentration C_{A} of a solute and comprising an electrode in contact with the electrolytic solution having a concentration C_{A};
b) a second reservoir B intended to receive an electrolytic solution having a concentration C_{B} of the same solute, C_{B} being lower than C_{A}, and comprising an electrode in contact with the electrolytic solution having a concentration C_{B};
c) a membrane separating the two reservoirs, said membrane comprising pores allowing the electrolytes to diffuse from reservoir A to reservoir B through said pore or pores; and
d) a device allowing to supply the electrical energy generated by the potential differential existing between the two electrodes, characterized in that the membrane comprises at least one layer formed of a cellulosic material comprising a network of crosslinked cellulose nanofibers and/or microfibers.

2. The device according to claim 1, wherein the thickness of the membrane is between 2 μm and 100 μm.

3. The device according to claim 1, wherein the membrane comprises from 10 to 20 g of cellulosic material per m² of membrane.

4. The device according to claim 1, wherein the nanofibers and/or the crosslinked cellulose microfibers are functionalized by negatively charged groups and/or groups which become negatively charged in the presence of water.

5. The device according to claim 1, wherein the nanofibers and/or the crosslinked cellulose microfibers are functionalized by positively charged groups and/or groups which become positively charged in the presence of water.

6. The device according to claim 1, wherein the membrane comprises a single layer formed of a cellulosic material comprising a network of crosslinked cellulose nanofibers and/or microfibers.

7. The device according to claim 1 wherein the membrane is a composite membrane comprising two outer layers each formed of a cellulosic material comprising a network of crosslinked cellulose nanofibers and/or microfibers, between which is disposed an inner layer formed of a second material comprising nanoparticles functionalized by charged groups and/or groups which become charged in the presence of water.

8. The device according to claim 7, wherein the thickness of each of the outer layers is between 2 μm and 25 μm, and the thickness of the inner layer is between 10 nm and 2 μm.

9. The device according to claim 7, wherein the nanoparticles are lamellar nanoparticles.

10. A method for producing electrical energy using a device as described in claim 1, comprising the following steps:
i) supplying an electrolytic solution having a solute concentration C_{A} in reservoir A, so that the electrode with which it is equipped is in contact with said solution,
ii) supplying an electrolytic solution having a concentration C_{B} of the same solute, C_{B} being lower than C_{A}, in the reservoir B, so that the electrode with which it is equipped is in contact with said solution,
iii) allowing the electrolytes to diffuse from reservoir A to reservoir B through the membrane,
iv) capturing the electrical energy generated by the potential differential existing between the two electrodes, using the device.

11. The method according to claim 10, wherein said electrolytic solutions are aqueous solutions comprising a solute selected from the group consisting of alkali halides and alkaline earth halides.

12. The method according to claim 10, wherein the concentration ratio C_{A}/C_{B} is greater than 1 and less than or equal to 10⁹.

13. The device according to claim 2, wherein the thickness of the membrane is between 2 μm and 75 μm.

14. The device according to claim 3, wherein the membrane comprises from 15 to 20 g of cellulosic material per m² of membrane.

15. The device according to claim 4, wherein the nanofibers and/or the crosslinked cellulose microfibers are functionalized by groups selected from the group consisting of the sulfonate group —SO₃⁻, the carboxylate group —CO₂⁻, the aminodiacetate group —N(CH₂CO₂⁻)₂, the phosphonate group PO₂³⁻; the amidoxine group —C(═NH₂)(NOH), the aminophosphonate group —CH₂—NH—CH₂—PO₃²⁻, the thiol group —SH, and mixtures thereof.

16. The device according to claim 5, wherein the nanofibers and/or the crosslinked cellulose microfibers are functionalized by groups selected from the group consisting of the quaternary ammonium group —N(R)₃⁺ with R being a C1-C4 alkyl, the tertiary ammonium group —N(H)R)₂⁺ with R being a C1-C4 alkyl, dimethylhydroxyethylammonium group —N(C₂H₄OH)CH₃)₂⁺, and mixtures thereof.

17. The device according to claim 16, wherein the tertiary ammonium group is —N(H)R)₂⁺ with R being a C1 alkyl.

18. The device according to claim 9, wherein the lamellar nanoparticles are lamellar nanoparticles of a metal oxide, of a dichalcogenide of a transition metal, carbon, or a mixture thereof.

19. The device according to claim 18, wherein the lamellar nanoparticles are lamellar nanoparticles of graphene oxide functionalized at the surface by negatively charged groups or groups which become negatively charged in the presence of water.

20. The device according to claim 18, wherein the lamellar nanoparticles of the dichalcogenide of a transition metal are lamellar nanoparticles of molybdenum disulfide.

21. The method according to claim 11, wherein said electrolytic solutions are aqueous solutions comprising a solute selected from the group consisting of NaCl, KCl, CaCl₂ and MgCl₂.

22. The method according to claim 12, wherein the concentration ratio C_{A}/C_{B} is greater than 1 and less than or equal to 10⁵.
